(19) United States
(12) Patent Application Publication
(10) Pub. No.: US 2005/0204002 A1
(43) Pub. Date: Sep. 15, 2005

(54) Dynamic online email catalog and trust relationship management system and method

(76) Inventor: Jeffrey Edward Friend, Marlton, NJ (US)

Correspondence Address: Jeffrey Edward Friend, P.O. Box 1383, Marlton, NJ, 08053, US

(21) Appl. No.: 10/779,154

(22) Filed: Feb. 16, 2004

(51) Int. Cl. G06F 15/16

(52) U.S. Cl. 709/206

(57) ABSTRACT

A system is described for a Dynamic Online Email Catalog useful in providing a means to collect, categorize, arrange, store and display direct email marketing messages for the benefit of users by way of secure web access to assigned private user areas. The catalog further provides a means for ranking received email messages within specific product or service categories with priority placement given to those messages originating with product or service providers having the highest trust scores in which the score is a number representing an average time that a user's email address is active with a specific provider. Also described is a system and method for searching Internet records involving the receiving of a search request, prioritizing records according to trust score with those associated with product and service providers having the highest trust score receiving priority placement.

### RELATION TO PRIOR APPLICATIONS

This patent application is based on and claims priority from U.S. patent application Ser. No. 10/346,333 entitled “Dynamic Online Email Catalog and Trust Relationship Management System and Method” filed Jan. 16, 2003, U.S. patent application Ser. No. 10/352,694 entitled “Dynamic Online Email Catalog and Trust Relationship Management System and Method” filed Jan. 26, 2003, U.S. patent application Ser. No. 10/359,346 entitled “Dynamic Online Email Catalog and Trust Relationship Management System and Method” filed Feb. 5, 2003, and U.S. patent application Ser. No. 09/648,905 entitled “Secure System for Conducting Electronic Transactions and Method For Use Thereof” filed Aug. 25, 2000 which are hereby incorporated by reference.

### FIELD OF INVENTION

The present invention is related to a system and method for a Dynamic Online Email Catalog featuring a common graphical user interface displaying a plurality of target email domains specific to individual second parties (e.g. merchants) or various product/service categories (e.g. women's shoes). The invention further provides for the incorporation of a system and method for producing a pseudo email address with a date and/or time stamp as a means of enabling the ranking of received email messages according to a trust score reflecting different functions of time (e.g. average) with respect to the length of time (i.e. life span) that individual user email addresses or different aggregate groups of user email addresses have been established with a particular second party (e.g. merchant) or a group of second parties (e.g. merchant affiliate network). The invention also provides a means for searching a database of records (e.g. Internet records) wherein search results are ranked according to the trust scores calculated for the second parties associated with the individual competing records.

### BACKGROUND

The invention relates to “opt in” relationship marketing (e.g. email, direct mail, telemarketing, instant messaging, web session registration, etc.).

Today the growing interest in email marketing for example as a valued customer relationship management tool is limited by the fact that email marketing messages sent either from or on behalf of merchants with whom consumers have elected to opt in become diluted in the presence of other unsolicited email marketing messages (i.e. spam). The result is that solicited messages likely to be more valued by the consumer are often deleted along with the unsolicited email. The same email messages also fail to realize maximum impact due to the fact that a consumer's regular email box does not provide the means by which the email messages can be effectively stored and displayed for future reference when a consumer might be in the mood and have the time to shop.

Another problem involves the scenario wherein there would be multiple independent parties (e.g. ISPs, credit card issuers, etc.) that would be creating, assigning and issuing pseudo email addresses to users (e.g. consumers) for distribution to second parties (e.g. merchants) as a way of protecting a user's privacy by shielding their regular email address from being abused by unsolicited marketers. This scenario would also have it that there would be one or more outside third parties (e.g. infomediaries), not necessarily the same as those independent parties issuing the email addresses, who wished to provide value-added service to users by aggregating, storing and manipulating incoming emails in a variety of means.

In the above mentioned scenario the outside third parties would be limited in their ability to provide a service for instance where the date and time of email creation and distribution would prove valuable. The information of date and time would be known only by those independent parties creating, assigning and issuing the email addresses.

The knowledge of date and time of email creation, assignment and issuance together with the identity of the specific second parties to which the emails were conveyed would be useful for example in establishing the date and time at which a user conveyed an email address to a specific second party as a matter of establishing one-to-one communication relationship. Knowing the date and/or time at which such relationship was formed and then comparing this information to the current date and/or time would provide a means of determining length of relationship between an individual user and a specific second party. Experts in the field of marketing are growing to recognize such determination of permitted one-to-one relationship as possibly the one most critical single measure of how much an individual values or trusts a particular relationship.

Thus it would be desirable to provide the means by which email marketing messages resulting from opt in decisions by consumers could be accumulated, stored and managed in a way that such messages could be accessed and used by consumers for an extended period of time.

It would further be desirable to provide the means by which pseudo email addresses created, assigned and issued by multiple independent parties for the purpose of providing users the means of secure one-to-one relationship with trusted second parties could incorporate information revealing the date and/or time at which the pseudo email address was created or exchanged as part of an electronic commerce transaction. Such means would prove useful in the scenario in which there would also be one or more outside third parties interested in the date and/or time of pseudo email creation, assignment or issuance as a matter of providing users a value-added service not necessarily provided by the same independent parties.

### SUMMARY OF THE INVENTION

In one aspect, the present invention provides a Dynamic Online Email Catalog that enhances the overall value of relationship email marketing by using means to collect, categorize, arrange, store and display direct email marketing messages prior to their reception at a consumer's regular electronic mailbox. Thus, in one embodiment of the invention a plurality of email marketing messages are collected, categorized, arranged, stored and displayed.

A preferred embodiment of the invention utilizes the incorporation of a date and/or time stamp in conjunction with the creation, issuance or use of a pseudo email address (defined as not the user's only or primary email address) assigned to a consumer in conjunction with an electronic commerce transaction. The date and/or time stamp also can reflect the date and/or time of transaction, or the date and/or time of the creation, assignment or issuance of a “limited use” credit or debit card number for use in an electronic commerce transaction.

Another aspect involves ranking of received email messages according to different functions of time (e.g. average) with respect to the length of time (i.e. life span) that individual user email addresses or different aggregate groups of user email addresses have been established with a particular second party (e.g. merchant) or a group of second parties (e.g. merchant affiliate network).

Another aspect involves the creation and management of new “from” email addresses in response to targeted emails received by a third party (e.g. Dynamic Online Email Catalog) from a second party affiliate(s) in which the new from address is attached to the received email message so as to forward the message by having it piggyback on the domain address of the sponsoring second party.

Another aspect involves the incorporation of an electronic language translator useful in providing multilingual translation into one or more target language texts in which a user is then provided with an option of viewing one or more of the target language tests with or without the source language texts.

Another aspect involves the incorporation of a system and method for searching a database of records (e.g. Internet records) in response to user requests for the purpose of locating and retrieving information in which search results are able to be displayed in rank order based upon different functions of time (e.g. average) with respect to the length of time (i.e. life span) that individual user email addresses or different aggregate groups of user email addresses have been established with a particular second party (e.g. merchant) or a group of second parties (e.g. merchant affiliate network) identified with the individual ranked search results.

This invention is not limited to email messages. Those skilled in the art may use similar systems and methods for managing electronic transactions involving other types of media relationships between users and second parties (e.g. telemarketing, or TV infomercial). The disclosure of my prior pending U.S. patent application Ser. No. 09/648,905 filed Aug. 25, 2000 and titled “SECURE SYSTEM FOR CONDUCTING ELECTRONIC TRANSACTIONS AND METHOD FOR USE THEREOF” is hereby incorporated herein in its entirety by reference.

### BRIEF DESCRIPTION OF THE DRAWINGS

FIG. 1 illustrates an embodiment of the graphical user interface of a Dynamic Online Email Catalog.

FIG. 2 illustrates an embodiment of a pseudo email address with date and/or time stamp.

FIG. 3 illustrates an embodiment of a system used in conjunction with the generation, issuance and use of pseudo email addresses.

FIG. 4 illustrates an embodiment of a method describing generally the steps involved with the generation, issuance and use of pseudo email addresses.

FIG. 5 illustrates an embodiment of a system used in conjunction with the transmission of email messages from a list server(s) sharing the same local area network with the Dynamic Online Email Catalog.

FIG. 6 illustrates an embodiment of a pseudo email address with date and/or time stamp and product/service category.

FIG. 6 illustrates an embodiment of a method describing generally the steps involved with the generation and issuance of new “from” email addresses in response to target email messages received from second parties.

FIG. 7 illustrates an embodiment of a system used in conjunction with the transmission of email messages from a list server(s) sharing the same local area network with the Dynamic Online Email Catalog.

FIG. 8 illustrates an embodiment of a system used in conjunction with a search engine capable of locating and retrieving information specific to private user areas and in response to user requests.

FIG. 9 illustrates an embodiment of an affiliate new “from” email address with date and/or time stamp and sponsoring second party domain address.

FIG. 10 illustrates an embodiment of those components of a system involved with providing a means for a second party affiliate(s) to send target emails to private user areas of a Dynamic Online Email Catalog by piggybacking email messages on the domain address of the sponsoring second party.

FIG. 11 illustrates an embodiment of a method describing generally the steps involved with the generation and issuance of new “from” email addresses in response to target email messages received from second party affiliate(s).

FIG. 12 illustrates an embodiment of the incorporation of an electronic language translator as added innovation of the present invention.

FIG. 13 is a block diagram illustrating the functional elements of a search apparatus useful for searching a database of records (e.g. Internet records) in response to user requests for the purpose of locating and retrieving information in which search results are able to be displayed in rank order based upon different functions of time (e.g. average) with respect to the length of time (i.e. life span) that individual user email addresses or different aggregate groups of user email addresses have been established with a particular second party (e.g. merchant) or a group of second parties (e.g. merchant affiliate network) identified with the individual ranked search results.

FIG. 14 is a flow chart illustrating an embodiment of the sequence of steps used by the search apparatus in performing a search.

### DETAILED DESCRIPTION OF THE INVENTION INCLUDING THE PREFERRED EMBODIMENTS

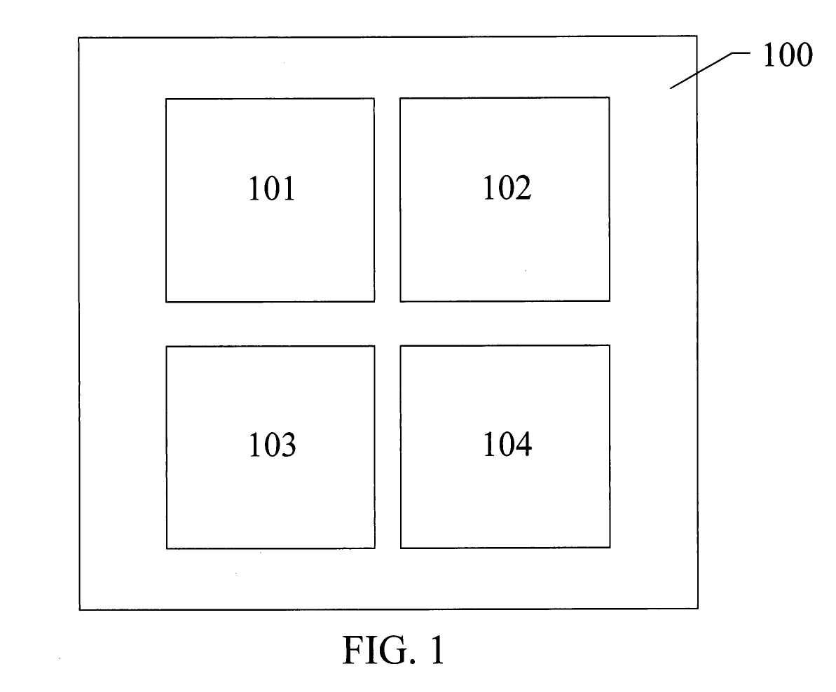

FIG. 1 illustrates an embodiment of the invention for a Dynamic Online Email Catalog. A key aspect of the invention is the creation of web site 100 to serve as an intermediary tool for accessing, viewing and responding to stored and managed email messages. The technology required for creating and operating the web site is readily available and in use today as a means for providing users web-based email (e.g. Internet Message Access Protocol (IMAP)) as a supplemental service to regular email (e.g. Post Office Protocol (POP)) accessed from their home PC.

Each user of the Dynamic Online Email Catalog preferably has an assigned private user area (i.e. personal catalog) within web site 100 that only they are able to access. Users are granted access to the private user area by going to the web site and entering their regular e-mail address or another static identifier that they submitted when they first signed up for the service. As an added security measure, one embodiment enables users to use a PIN (Personal Identification Number) together with their static identifier. Other available means of secure access include users clicking on a prompt available on their PC home page, e-wallet, digital phone screen, etc.

Preferably, within each private user area is found a plurality of mailboxes 101, 102, 103, 104. The mailboxes are arranged so as to populate the screen much like different product categories and listings in conventional online catalogs. FIG. 1 shows one embodiment including four mailboxes of equal size and proportion. Another embodiment provides for increasing numbers of mailboxes to be added to the display. Another embodiment provides for multiple web pages to accommodate added mailboxes. Another embodiment calls for the mailboxes to be arranged in various ways and among other graphics and hyperlinks so as to increase the style and flexibility of the information choices provided through the display. Each mailbox is preferably labeled with specific product and service categories (e.g. men's casual wear, insurance services, etc.) or alternatively the names of specific product/service providers (e.g. merchants) depending on the intended use of the mailbox.

The infrastructure supporting web site 100 (servers, database, mail boxes, etc.) receives the email messages sent using pseudo e-mail addresses that users are assigned in the course of executing electronic commerce transactions. This is preferably accomplished by distinguishing the domain address of the Dynamic Online Email Catalog similar to those commonly used for ISPs or other businesses.

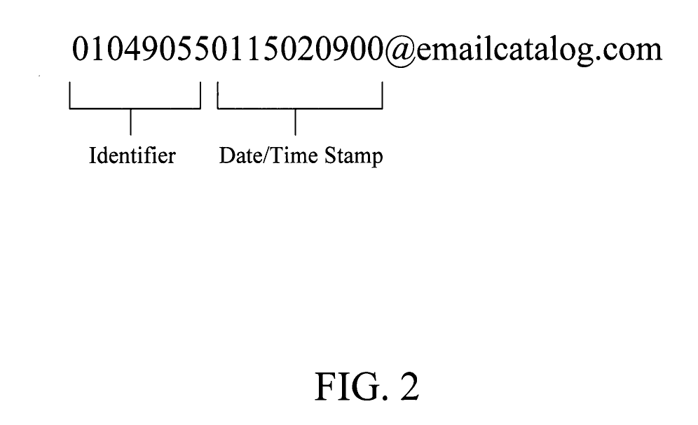

FIG. 2 illustrates an embodiment of a pseudo email address with date and/or time stamp. A preferred pseudo email address includes an identifier portion in addition to the date and/or time stamp portion. The identifier portion preferably contains one or more fields and consists of alphanumeric characters or alternatively characters from an extended character set. It is used to send email to the designated recipient. The date and/or time stamp portion reflects the date and/or time of generation, issuance, or use as part of an electronic commerce transaction. Shown also is a preferred embodiment in which the pseudo email address includes a standard format for a web domain email address. The illustration of the email address is just one example of the number of fields and choice of fields that may be used.

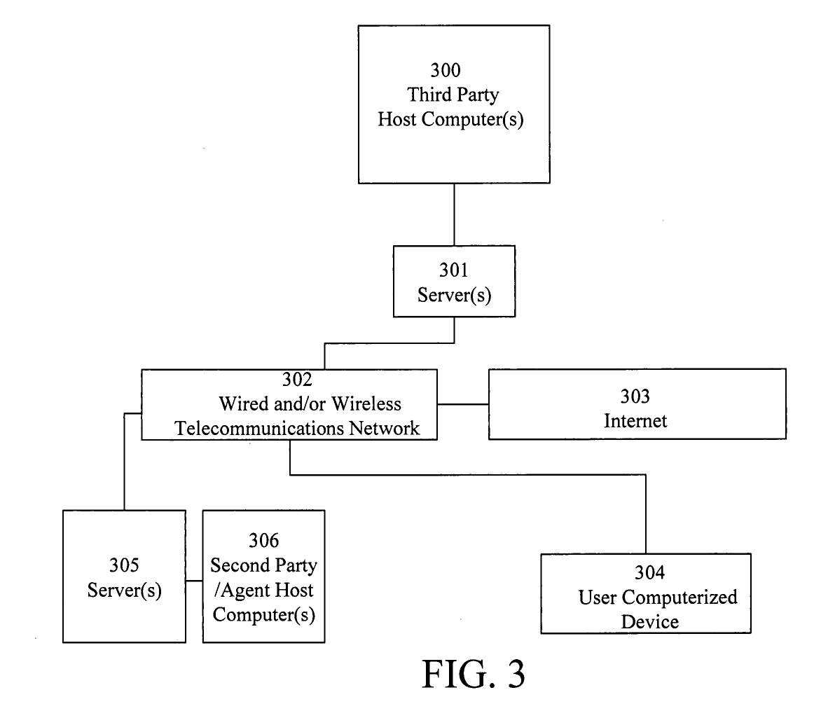

FIG. 3 illustrates an embodiment of the system for the generation and issuance of a pseudo email address. Third Party Host Computer(s) 300 is connected to Internet 303 via Server(s) 301 and Wired and/or Wireless Telecommunications Network 302. User Computerized Device 304 is connected to Internet 303 via Wired and/or Wireless Telecommunications Network 302. Second Party and/or Agent Host Computer(s) 306 is connected to Internet 303 via Server(s) 305 and Wired and/or Wireless Telecommunications Network 302.

Contained within Third Party Host Computer(s) 300 is a system including microprocessor(s), random access memory, hard disk(s), a clock, and a custom software application capable of generating and assigning date and/or time stamped random and/or variable identifiers to users in response to requests.

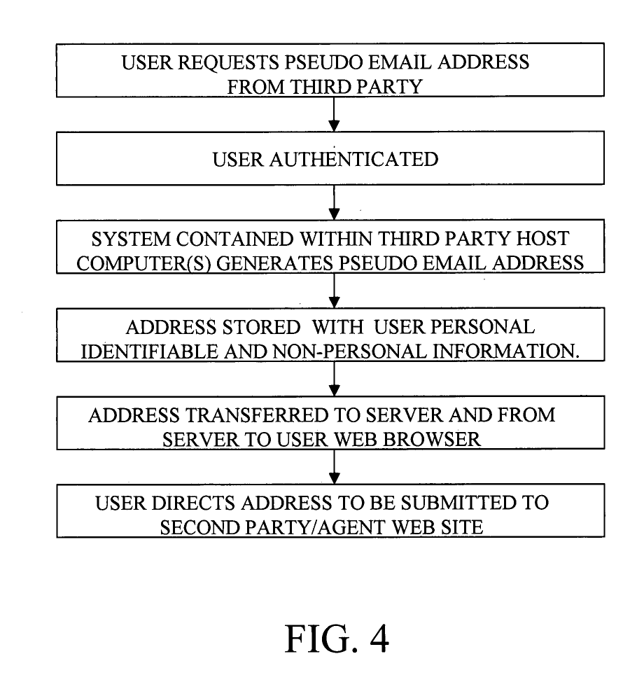

FIG. 4 illustrates an embodiment of a method used in conjunction with the system illustrated in FIG. 3 to generate, issue and store pseudo email addresses in combination with user personally identifiable information (e.g. name, primary email address, credit card primary account number, etc.) and/or non-personally identifiable information (e.g. demographic profile, financial net worth, etc.).

To use the system, a user requests a pseudo email address from a third party. The third party can be enlisted as an agent of the second party or an agent of the user. In the event the third party is enlisted as an agent of the user, the personally identifiable and non-personally identifiable information of the user would be previously stored by or made available to the third party in advance of the request for a pseudo email address unless the user was not known to the agent in which case there would be involved the step of registration.

In the event the third party is an agent of the second party, the personally identifiable and non-personally identifiable information of the user would be requested and selectively submitted by the user or made available by permission of the user as part of the process of establishing a pseudo email address.

In receiving the request for a pseudo email address, a process of authentication is preferably initiated by a system operating in conjunction with the Third Party Host(s) Computers 300. Upon successful authentication of the user, the system generates the pseudo email address, stores the address with the user personally identifiable and non-personally identifiable information, transfers the address to Server(s) 301 and from there via Wired and/or Wireless Telecommunications Network 302 and Internet 303 to the user's web browser operating in conjunction with User Computerized Device 304.

In the event the third party is an agent of the second party, there is an alternative embodiment in which the newly generated pseudo email address remains with the third party and is not transferred to the user web browser.

By whatever means it is accomplished, once issued the pseudo email address would function just like a regular email address. The same process preferably allows the user to retain the ability to discontinue or suspend the active status of the posted pseudo email address similar to the methods currently employed for both pseudo email addresses and limited use credit or debit card numbers. The user preferably is able to perform the steps necessary for discontinuing or suspending the active status of a posted email address by clicking a selection(s) available in their private user area. This function would require custom-written software.

In the event that the third party providing the pseudo email address to the user is not the same third party providing the service of the Dynamic Online Email Catalog, an established contractual arrangement between the parties would lay the groundwork for a process in which a second pseudo email address would be created for use as a forwarding address in an effort to federate the previously established relationship between the user and the first third party and the provider of the Dynamic Online Email Catalog. The steps involved with providing the second pseudo email to the Dynamic Online Email Catalog would also involve establishing a communication link through which the non-personally identifiable information of the user would also be made available.

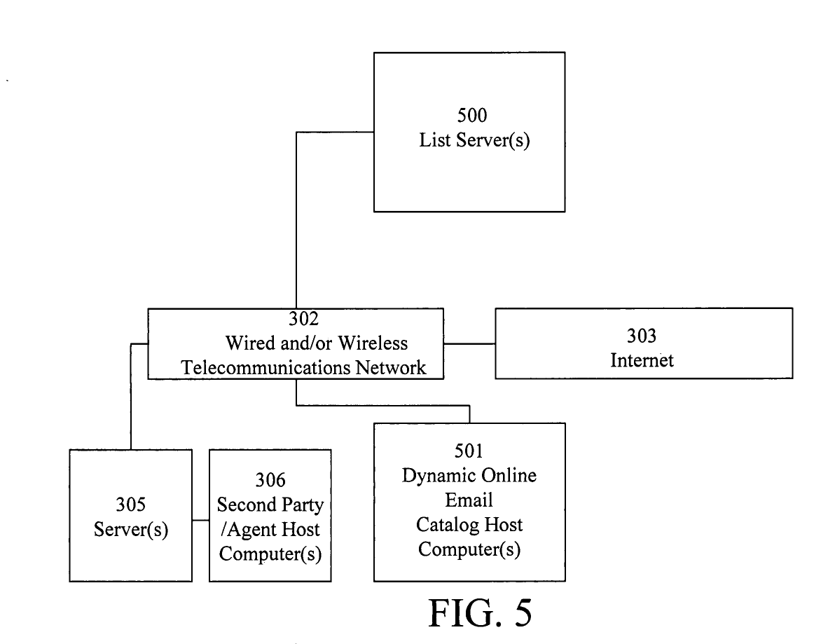

FIG. 5 illustrates an embodiment of the system involved with the process in which email messages are forwarded to List Server(s) 500 and Dynamic Online Email Catalog Host Computer(s) 501 from Second Party Host Computer(s) 306 using Wired and/or Wireless Telecommunications Network 302 and Internet 303.

Contained within List Server(s) 500 and Dynamic Online Email Catalog Host Computer(s) 501 is a system including microprocessor(s), random access memory, hard disk(s), a clock, and preferably a custom software application incorporating sophisticated filtering software. The use of filtering software as part of a preferred embodiment enables incoming email messages to be parsed as part of a process in which certain words are identified and matched against updated word sets associated with specific mailboxes so as to accurately direct email messages to the appropriate mailbox assigned to a specific product/service category or alternatively to a specific second party. The process also preferably involves steps in which a correlating mailbox identifier is inserted into the email address so as to correctly address incoming email messages for final delivery. An alternative embodiment includes substitution of code numbers in place of actual descriptors. Technology capable of meeting the requirements of these embodiments is readily available.

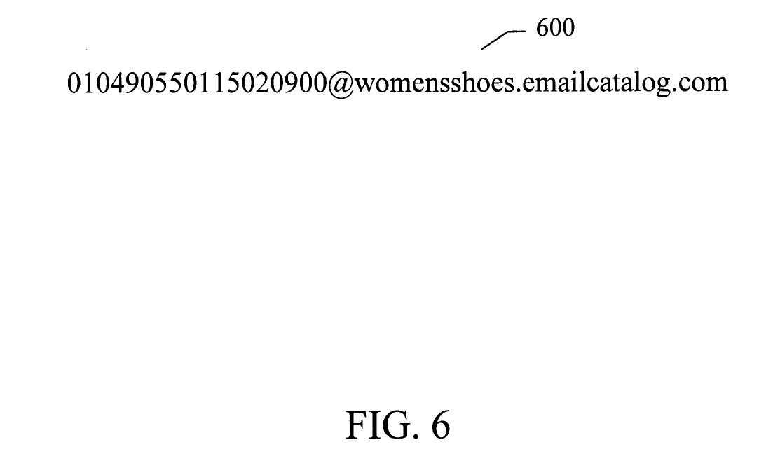

FIG. 6 illustrates an embodiment of a pseudo email address with Product/Service Sub Domain Address 600. In this example, the category “women's shoes” is inserted into the email address as a sub domain address. This allows incoming email messages to be targeted to specific product/service categories contained within the Dynamic Online Email Catalog. The illustration of the email address is just one example of the number of fields and choice of fields that may be used.

Organization of email messages in the Dynamic Online Email Catalog is further enhanced by preferably having newly incoming email messages to specific mailboxes take priority position within specific retail categories over previously sent emails from the same originating address. This preferably involves having incoming emails trigger the sub-listing or deletion of previously received email messages so as to avoid a situation in which a deluge of emails from a specific second party would bury competing emails messages from other second parties.

The exception would be the scenario in which specific mailboxes appearing in a private user area are assigned exclusively to specific product/service providers. Here, second parties or their agents are preferably able to select the amount of email storage capacity they wish to maintain in conjunction with various user accounts with the total charges for storage being determined based upon the amount of storage leased. Second parties or their agents are also preferably able to tailor storage capacity to fit particular user profiles (e.g. customers who access the Dynamic Online Email Catalog at a certain frequency, customers known to have made past purchases, or customers exceeding a certain spending amount, etc.).

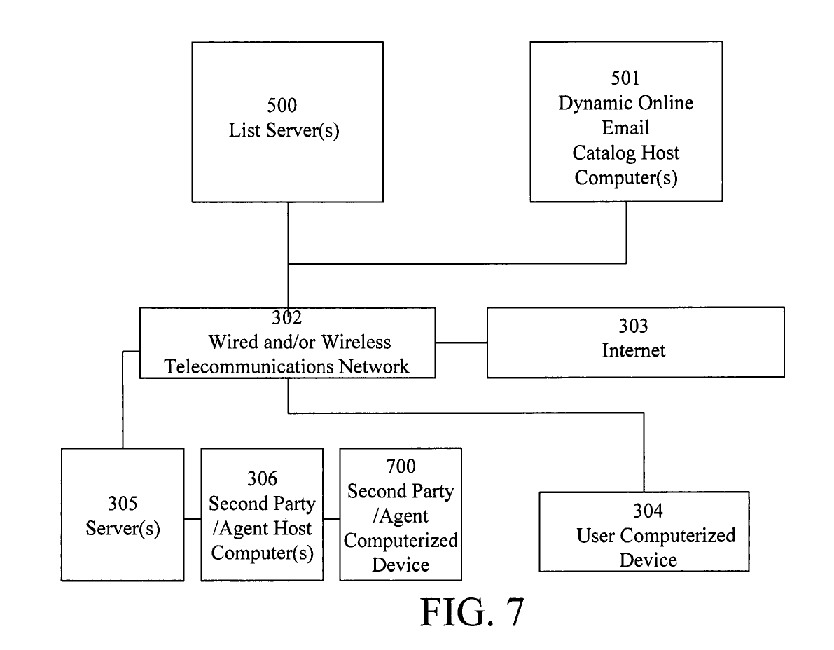

FIG. 7 illustrates a preferred embodiment of the system in which List Server(s) 500 shares the same local area network as Dynamic Online Email Catalog Host Computer(s) 501.

One embodiment provides for both personally identifiable and non-personally identifiable information gathered from participating users being recorded to a database in conjunction with the various pseudo email addresses assigned to a user in relation to specific second parties. The stored information is also preferably indexed according to different product/service categories and demographic profile classifications. The database is preferably queried by List Server(s) 500 using custom written applications providing the means of continually updating mailing lists to account for those pseudo email addresses that have been deactivated by users.

One embodiment provides for a process involving use of mailing lists for delivering email messages as a value added service to second parties, especially those lacking the technology or ability to pursue a sophisticated targeted email campaign. The process preferably involves steps in which a second party and/or agent uses Second Party or Agent Computerized Device 700 and Second Party or Agent Host Computer(s) 306 to request and receive secure access to List Server(s) 500 via Wired and/or Wireless Telecommunications Network 302 and Internet 303 for the purpose of uploading email templates for ultimate distribution to Dynamic Online Email Catalog Host Computer(s) 501, the second party and/or agent selects from specific product/service categories and specific demographic classifications and/or inputs other data thus allowing their preferences for intended delivery of a particular email message to be transmitted to List Server Host Computer(s) 500, using an identifier specific to the second party or agent a custom written application operating in conjunction with List Server Host Computer(s) 500 queries the database in which the personal and non-personally identifying information of users is stored, the identifier limits the query to accessing only those accounts identified by active pseudo email addresses relative to the second party or agent, the identified active pseudo email addresses are extracted and applied to the email message, using a custom written software application additional information is added to the pseudo email address so as to correctly address incoming email messages for final delivery, the email message is placed in queue for delivery, the email message is forwarded to each designated mailbox.

A user is able to access information stored in conjunction with Dynamic Online Email Catalog Host Computer(s) 501 preferably via web access using a web browser operating on Computerized Device 304. Upon successful authentication, an application operating in conjunction with Host Computer(s) 501 is invoked whereby a query is made to the database and information relevant to the user account, including stored email messages, is retrieved and transmitted via Wired and/or Wireless Telecommunications Network 302 and Internet 303 to the user web browser. Using a keyboard or mouse the user is then able to select specific emails listed within mailboxes 101, 102, 103, 104. Clicking on an individual email causes the message to expand so that it can be read and any rich email content viewed. Users are also able to scroll emails up and down so the complete content can be digested. In addition, users are preferably able to click on hyperlinks contained within an email message which causes a request to be redirected by way of Host Computer(s) 501 and transmitted via Wired and/or Wireless Telecommunications Network 302 and Internet 303 to a second party web site where the user is then able continue browsing while still logged into Host Computer(s) 501. When finished browsing emails and other linked content, a user is able to log out of the Dynamic Online Email Catalog whereby the application serving the private user area is closed. It is also preferable that sophisticated security measures be incorporated to protect against abuse of the system.

One embodiment involves the use of the date and/or time stamp of the pseudo email addresses used in conjunction with incoming marketing messages to help in enabling a process in which incoming email messages within certain product and service categories are displayed in rank order based on the average length of “customer relationship” maintained by individual merchants across all of their participating users or as an alternative embodiment those participating users of a certain profile classification. This is preferably accomplished by a process in which a comparison is conducted of all active and deactivated or suspended date and/or time stamped email addresses established with individual second parties. The process operates in conjunction with Dynamic Online Email Catalog Host Computer(s) 501. The ranking of received email messages would be prioritized according to a trust score reflecting different functions of time (e.g. average) with respect to the total relative lengths of time (i.e. life spans) that individual user email addresses or different aggregate groups of user email addresses have been established with a specific second party or a group of second parties (e.g. merchant affiliate network) wherein those scores reflecting longer life spans are given higher priority placement and as a result higher visibility within mailboxes 101, 102, 103, 104 displayed on web page 100. Supporting this is preferably a process similar to the means in which conventional HTML email is managed wherein it is common that some or all of the content (e.g. graphics and/or heading) of the first received of unread emails is made visible to the user.

An simplified example of a trust score calculation is able to be illustrated by considering two different merchants each of them with three customers having active pseudo email address accounts and three customer names associated with deactivated pseudo email addresses. In order to determine a trust score, one embodiment involving a custom written application operating in conjunction with Dynamic Online Email Catalog Host Computer(s) 501 looks at the date and/or time stamps of the three active addresses for each merchant, looks at the current date and time, calculates a snapshot of the combined total length of time for the three active addresses for each merchant, looks at the date and/or time stamps of the three deactivated addresses for each merchant, looks at the date and time the addresses were deactivated, calculates the combined total length of time for the three deactivated addresses for each merchant, adds together the combined total lengths of time for both the three active and three deactivated addresses for each merchant, divides by six the total resulting from the addition of the combined lengths of time for both the three active and three deactivated addresses for each merchant. The same embodiment then compares the two time averages and determines the highest time average (i.e. trust score).

When a user accesses a private user area, the act of doing so preferably invokes a process whereby the trust scores of the second parties are calculated in real time and compared. This information is taken into account with the result being that the email messages originating from second parties with higher trust scores are given priority placement in each of the mailboxes displayed by the Dynamic Online Email Catalog. An alternative embodiment less demanding on the operational demands of the system provides for the trust score to be calculated once every 24 hours for all product and service providers.

Use of the trust score ranking system would be preferable in the situation where second parties are limited to one email per each product/service category mailbox in a user private area.

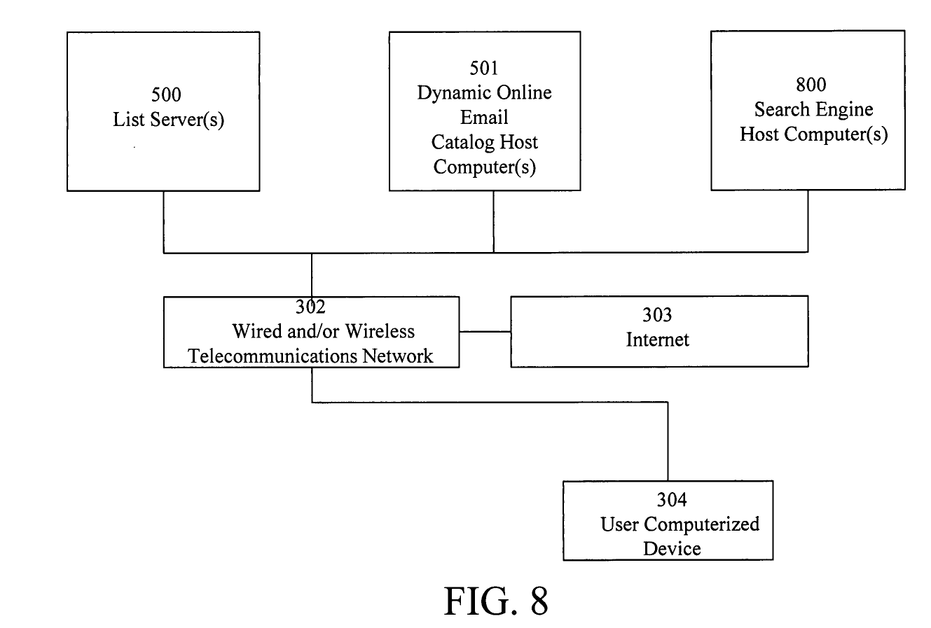

FIG. 8 illustrates an embodiment of a system used in conjunction with a means of searching for, locating and retrieving information within specific private user areas of the Dynamic Online Email Catalog in response to requests initiated by users assigned to those areas. The search apparatus operates in conjunction with Search Engine Host Computer(s) 800 which a user is able to access from User Computerized Device 103 via Wired and/or Wireless Telecommunications Network 302 and Internet 303. An embodiment of a method used in conjunction with the system involves those steps in which a user preferably inputs a product/service category or alternatively a specific second party name, the user triggers the search engine by clicking an icon appearing as part of the GUI provided in conjunction with a private user area, the custom written application supporting the search engine function queries the database using the inputted product/service category or specific second party name, the location of the inputted product/service category or specific second party name triggers a process by which a display is retrieved and displayed.

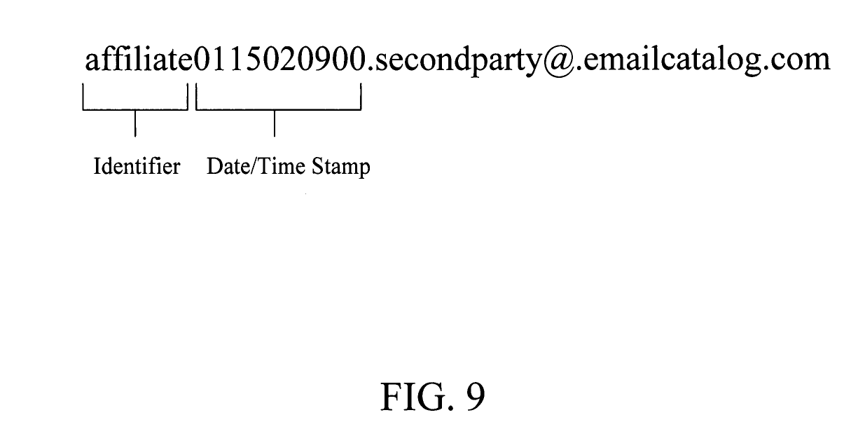

FIG. 9 illustrates an embodiment of an affiliate new “from” email address with date and/or time stamp. Preferably the from email address includes an identifier portion containing the real business name of the affiliate in addition to the date and/or time stamp portion. An alternative embodiment provides the identifier portion to contain the real domain name most readily identified with the affiliate. The identifier portion preferably contains one or more fields comprised of alphanumeric characters or alternatively characters from an extended character set. The date and/or time stamp portion preferably reflects the date and/or time of generation, issuance, or use of a new from email address in response to the receiving of a target email message from a second party affiliate. Shown also is a preferred embodiment in which the from email address includes a standard format for a web domain email address including preferably the real business of the second party or alternatively the real domain name most readily identified with the affiliate. The illustration of the from email address is just one example of the number of fields and choice of fields that may be used.

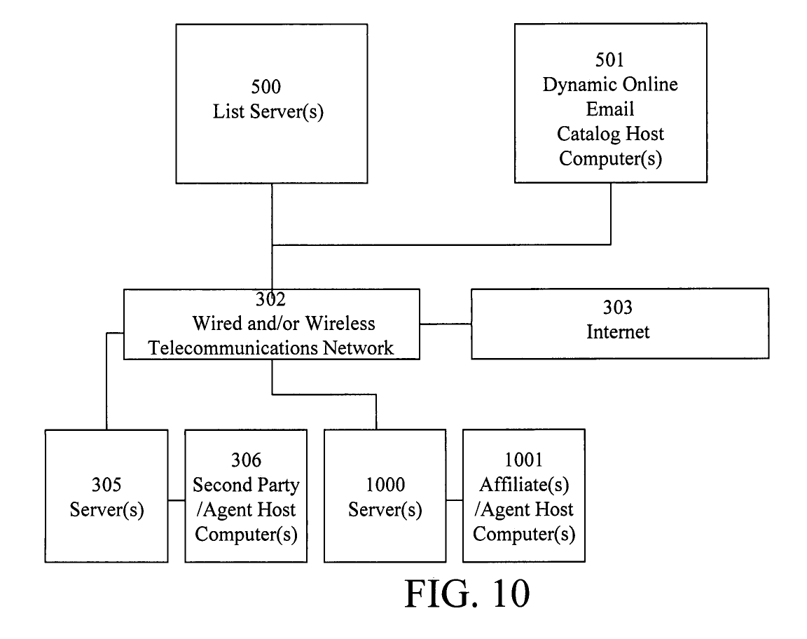

FIG. 10 illustrates an embodiment of those components of a system involved with providing a means for a second party affiliate(s) to send target emails to private user areas of a Dynamic Online Email Catalog by piggybacking email messages on the domain address of the sponsoring second party. Second Party Affiliate(s) Host Computer(s) 1001 connects via Server(s) 1000 to Wired and/or Wireless Telecommunications Network 302 and Internet 303 through which a communication link is able to be formed with List Server(s) 500 and ultimately Dynamic Online Email Catalog Host Computer(s) 501. A target email template originating with the second party affiliate(s) is preferably sent not directly to a private user area(s) of the Dynamic Online Email Catalog Host Computer(s) 501, but rather to an established account of the sponsoring second party using an email address such as “secondparty@emailcatalog.com.”

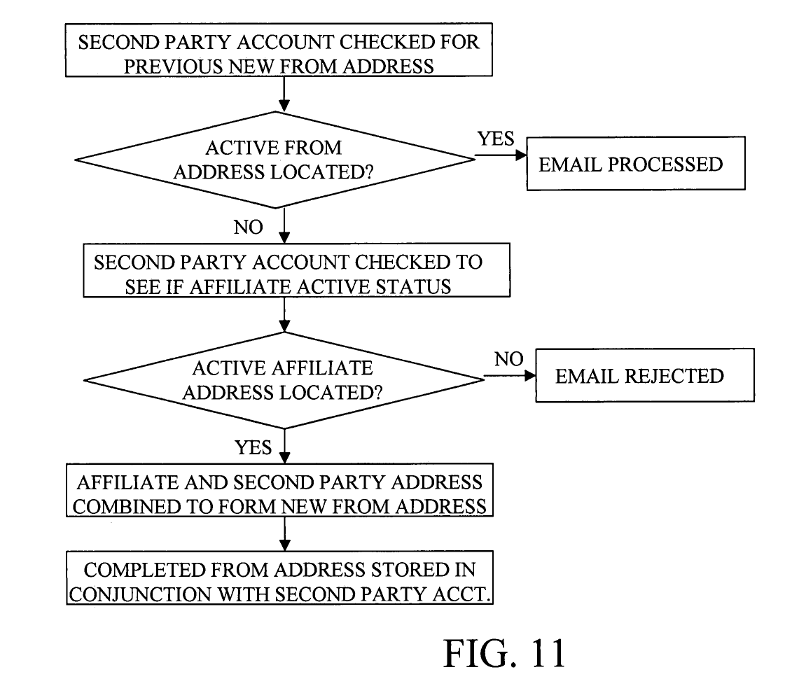

FIG. 11 illustrates an embodiment of a method describing generally the steps involved with the generation and issuance of new “from” email addresses in response to target email messages received from second party affiliates. In the example shown, the steps preferably include the receipt of an email template triggering a process in which the from address is extracted and used as part of a query made to an established account of a second party to check to see if an active from address incorporating both the affiliate and the second party identifiers is present, if an active from address is located then the from address is substituted in place of the originating from address and the email is processed using similar means to target emails received from second parties using established pseudo email addresses, if an active from address is not located then second party account is checked to see if the from address is active status, if the from address is not located or located and determined to be not of “active” status then the email is rejected, if the from address is located and determined to be active a process is triggered in which the from address is combined with the domain address of the second party to which the email was sent to form a new “from” email address and in forming a new from address, the new from address is substituted in place of the originating from address and the email is processed using similar means to target emails received from second parties using established pseudo email addresses.

A preferred embodiment provides that the date and/or time appearing in conjunction with an affiliate from email address be referenced similar to the date and/or time appearing in conjunction with established pseudo email addresses as part of the process involving the ranking of email messages.

When it comes to a user sending an email in response to a target email received from an affiliate, preferably the process is similar to re-mailing whereby the new from email address is stripped and replaced by the original from address so as to facilitate proper routing of the email message.

Note that a preferred embodiment provides that future emails sent by the affiliate are still required to be sent in care of the sponsoring second party as a custom written software application operating in conjunction with Dynamic Online Email Catalog 501 and List Server(s) 500 is employed to restrict any direct communications involving use of an established pseudo email address to the domain address of the second party.

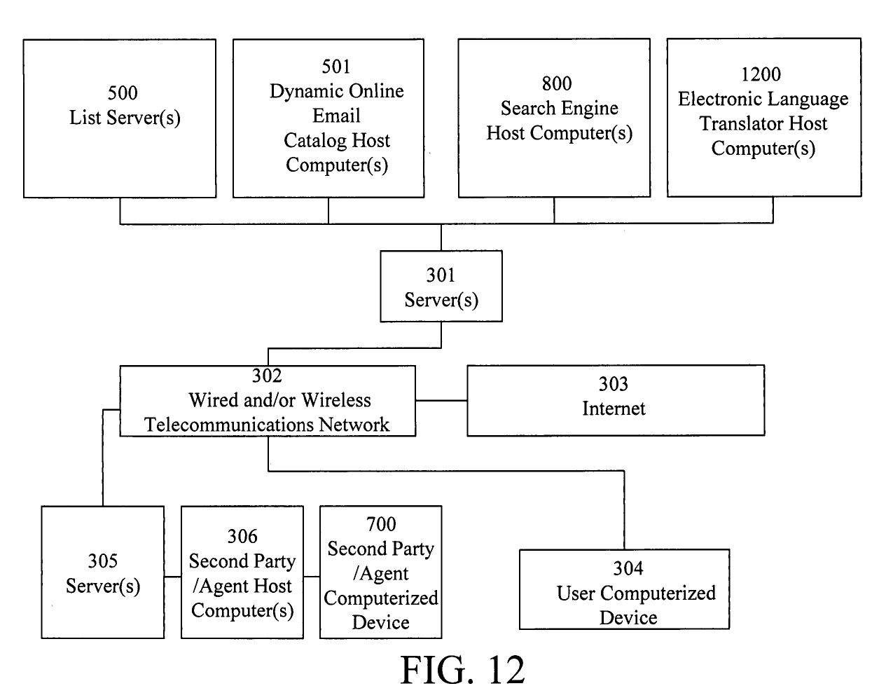

FIG. 12 illustrates an embodiment of the incorporation of an electronic language translator as an added innovation to the present invention. Shown are Electronic Language Translator Host Computer(s) 1200 preferably as a separate system functioning as part of the same local area network in conjunction with the Dynamic Online Email Catalog Host Computer(s) 501 and List Server(s) 500 and Search Engine Host Computer(s) 800. A system and method for providing an electronic language translator capable of meeting the requirements of the current invention is described in U.S. Patent Document 20010029455 “Method and apparatus for providing multilingual translation over a network” and is hereby incorporated herein in its entirety by reference.

In U.S. Patent Document 20010029455 there is described a means in which a source language text (e.g. English) is received as an input to the electronic language translator, the source language test is translated at the electronic language translator at the time of submission into one or more target language texts (e.g. Japanese), and a user is then provided with an option of viewing one or more of the target language texts with or without the source language text. U.S. Patent Document 20010029455 further describes a data provider as being any device that supplies either static or dynamic data to a client device over the data transmission infrastructure wherein the invention of an electronic language translator is capable of acting as an intermediary in data exchange, translating the data from one language to another as it passes from client device to data provider, from data provider to client device, or from client device to client device.

The present invention provides the incorporation of such a means for an electronic language translator wherein a Dynamic Online Email Catalog Host Computer(s) 501, Search Engine Host Computer(s) 800, and Second Party or Agent Host Computer(s) 306 are examples of devices supplying either static or dynamic data to User Computerized Device 304 and List Server(s) is an example of a device supplying similar data to Second Party or Agent Host Computer(s) 306 and Second Party or Agent Computerized Device 700 is a second client device to complement User Computerized Device 304.

Note that those skilled in the art may use similar systems and methods in meeting the requirements of an electronic language translator.

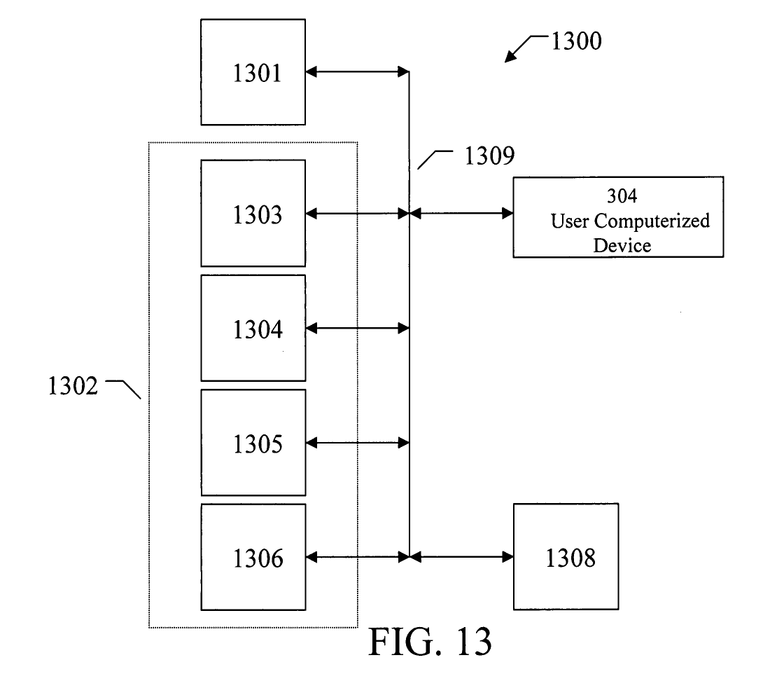

FIG. 13 is a block diagram illustrating the functional elements of a search apparatus incorporating that aspect of the invention involved with searching a database of records (e.g. Internet records, email records across different aggregate user groups) in response to user requests for the purpose of locating and retrieving information in which the search results are able to be displayed in rank order based on different functions of time (e.g. average) with respect to the length of time (i.e. life span) that individual user email addresses or different aggregate groups of user email addresses have been established with a particular second party (e.g. merchant) or a group of second parties (e.g. merchant affiliate network) identified with the individual ranked search results. A system and method for providing a search apparatus and method capable of meeting the requirements of the current invention with certain modifications is described in U.S. Pat. No. 5,924,090 “Method and apparatus for searching a database of records” and is hereby incorporated herein in its; entirety by reference.

The search apparatus operates in conjunction with Search Engine Host Computer(s) 800 which a user is able to access from User Computerized Device 103 via Wired and/or Wireless Telecommunications Network 302 and Internet 303. According to a preferred embodiment, the apparatus 1300 includes a search processor 1301 and a grouping processor 1302. The grouping processor comprises a record processor 1303, a candidate generator 1304, a weighing processor 1305, and a display processor 1306. These elements are software modules and have been so identified merely to illustrate the functionality of the invention. The apparatus 1300 communicates with a User Computerized Device 304 (Note that alternatively a conventional telephone can be substituted in conjunction with a sophisticated voice activation system) and a database(s) 1308, which preferably includes Internet and push driven content records (e.g. target email messages), via an I/O bus 1309. The apparatus 1300 is capable of communicating with a plurality of remotely located users over a wide area network (e.g. the Internet).

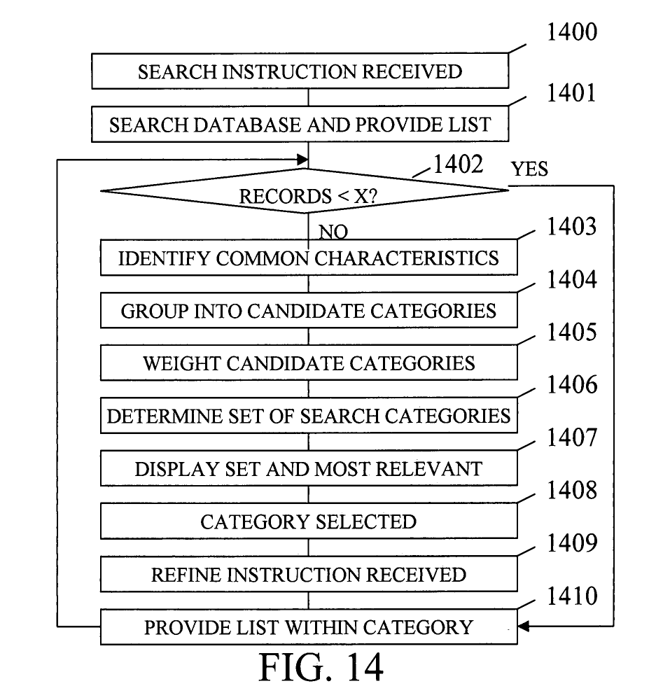

FIG. 14 is a flow chart illustrating the sequence of steps used by the search apparatus in performing a search. With reference to FIGS. 13 and 14, the search processor 1301 receives search instructions (i.e., a query) from a User Computerized Device 304 via the bus 1309 (step 1400). The search processor 1301 searches the database(s) 1308 and generates a search result list corresponding to a selected set of the records (step 1401). The selected set of records are ranked according to relevancy criteria.

In one embodiment, an example of the relevancy criteria for ranking the records preferably includes the following rules:
1. If there are more “hits” (a word in a record matching a word in the search criteria), the record ranks higher;
2. If the query term phrase is a hit versus the words separately being hits, the record ranks higher;
3. If the capitalization is the same as in the query term, the record ranks higher;
4. If the query term is in the title, the record ranks higher;
5. If the query term is in the abstract, the record ranks higher; and
6. If the query term is in the keywords, the record ranks higher.

7. If a current calculated trust score is available for a second party identified in conjunction with the record, the record ranks higher.

8. If a current calculated trust score for a second party identified in conjunction with the record is greater than other available trust scores for other second parties identified in conjunction with competing records, the record ranks higher.

An additional embodiment provides for the incorporation of relevancy criteria reflecting trust scoring to be further limited to those stored active pseudo email addresses belonging to users defined by certain non-personally identifiable information (e.g. sex, age, income, net worth, average net worth growth rate, etc.) These personal profile characteristics are able to be selected and inputted in conjunction with the search term either by the user in initiating a search or alternatively as a matter of process involving further enhancements of the invention in which non-personally identifiable information of the user (e.g. current net worth) is able to be automatically referenced and incorporated on behalf of the user.

### Alternative Embodiments

An alternative embodiment provides for the use of various systems and software applications to accommodate alternative media messages.

An example of such a message is an audible recorded messages for use in telemarketing. Here, a user phone number or some form of proxy identifier would be used to forward the audible recorded messages to the user. The system would involve the use of designated secure voicemail box similar to the function of a Dynamic Online Email Catalog.

Second parties would be able to forward telemarketing messages to the voicemail box using an automatic dialer similar to the use of a list server in forwarding targeted email messages. Incoming messages would be stored within different product/service categories that users would be able to select by either touching their keypad or simply speaking and having their instructions interpreted by a sophisticated voice activation software application. Users are able to access the voicemail box by dialing a special telephone number or possibly exercising an option offered through their primary voicemail service. Security could also be enhanced by requiring the input of a PIN or through use of voice authentication.

The incoming telemarketing messages also can include a date and/or time stamp reflecting the time the user agreed to allow voicemail messages to be forwarded by a particular second party or association. The date and/or time stamp also can be derived from the date and/or time stamp applied to a user pseudo email address established with the same second party. Similar to the Dynamic Online Email Catalog, the voicemail catalog would rank voicemail messages within specific categories based upon a function of the length of relationship of individual users or different aggregate groups of users.

Another alternative involves TV infomercials. Those skilled in the art are able to envision a similar system and method in which infomercials would be forwarded to an electronic box capable of storing digital television signals. The targeted infomercial mailbox would be available through a designated channel that users would access by touching the keypad on their TV remote or other means. Having arrived at the channel users would be able to select from various categories using a special function on their remote. Similar to the Dynamic Online Email Catalog, the infomercial mailbox channel could highlight different categories or premium listings within a category through the use of rich graphic or video content. Again, the received infomercials also can be ranked based upon relative length of trust relationship among individual users or different aggregate groups of users. A date and/or time stamp also can be incorporated as part of a special identifier and reflect the date and/or time stamp applied to a user pseudo email address established with the same second party.

Another alternative provides a means in which emails, voicemails and infomercials would not be pre-transmitted to a central storage media (box) but remain with the host of second party or agent until requested as a result of a signal being received from a user. In such instance, information is transmitted to the box and the user can make a request to receive the full message based on the information.

Another alternative provides a means in which target email messages originating with second party affiliates are sent first to the sponsoring second party for the purpose of being forwarded to users by a method in which the affiliate email message is able to piggyback by way of a communication link involving the second party. One embodiment involves a system and method similar to the above described preferred embodiment providing for the from email address of the affiliate to be combined with that of the second party in order to create a new from email address. An alternative embodiment involves a system and method providing for the affiliate email message to be forwarded using active pseudo email address or addresses established with the second party in which the from address can reflect the identity of the affiliate or the identity of the second party although this is considered less desirable in that it deprives the user the ability to immediately identify the true originator of a received email message.

The hardware components needed for implementing this invention are currently in existence. However, it is expected that some custom written applications can be desired to assure smooth flow within the system. Such software can be readily written be a ordinarily skilled programmer.

Although the invention has been described in detail, it is to be understood that variations therein and modifications thereto may be made by those skilled in the art without departing from the spirit and scope of the invention as set forth. For example, the functions of the various components used within the system can be provided by various microprocessors, servers and memory storage devices working together in a system. Also, if the Third Party Host Computer also operates the Dynamic Online Email Catalog Host Computer, the time stamp can be internally associated with the user email address in place of a component of the email address. The invention is also not limited by the terminology used to describe the invention or various embodiments herein.

1. A Dynamic Online Email Catalog comprising means to collect, categorize, arrange, store and display direct email marketing messages to a designated recipient.

2. The Dynamic Online Email Catalog of claim 1, further comprising means for processing the email to place in categories.

3. The Dynamic Online Email Catalog of claim 1, further comprising means for arranging and storing the a plurality of email messages in categories according to subject matter.

4. The Dynamic Online Email Catalog of claim 1, further comprising means for assigning a trust score to the message and means for ranking the messages in accord with the trust score wherein a trust score is a number that represents an average time that a user's email address is active with a product or service provider based on both those that have been deactivated plus those that are active.

5. The Dynamic Online Email Catalog of claim 1, further comprising means for translating a message from a first language to a second language.

6. A method for handling and enhancing utilization of email marketing messages to a designated recipient, the method comprising collecting, categorizing, arranging and storing the email marketing messages in a central data base, and displaying the messages in an arranged format for use by the designated recipient.

7. An email address format comprising a plurality of portions including an identifier portion associated with a designated user, a date/time stamp portion and web site identifier portion.

8. The email address format of claim 7, further comprising a vendor identifier portion.

9. The email address format of claim 7, further comprising a category identifier portion.

10. A system for managing a mailing list, the system comprising:
means for processing email messages received from second party affiliates by extracting a portion of the originating “from” address to create a new “from” address combining with a portion of the domain address of a sponsoring second party, and
means for forwarding the email pursuant to a request for messages relating to a particular desired subject matter.

11. A search apparatus comprising:
means for searching for records identified by a descriptor supplied by a designated user;
means for ranking the records within a search results list with priority given to those records associated with a product or service provider having a trust score wherein a trust score is a number that represents an average time that a user's email address is active with a product or service provider based on both those that have been deactivated plus those that are active.
means for ranking the records within a search results list with priority given to those records associated with a product or service provider having a higher trust score wherein a trust score is a number that represents an average time that a user's email address is active with a product or service provider based on both those that have been deactivated plus those that are active.

12. A method for searching and prioritizing the results, the method comprising receiving a search request, searching the Internet for records, prioritizing records in accord with a trust score, and displaying the results prioritized by the trust score.
